(19) United States
(12) Patent Application Publication
(10) Pub. No.: US 2006/0234634 A1
(43) Pub. Date: Oct. 19, 2006

(54) Integrated circuit comprising a transmission channel with an integrated independent tester

(76) Inventors: Benoit Agnus, Cannes (FR); Yannick Grasset, Vallauris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/537,885

(22) PCT Filed: Dec. 1, 2003
(86) PCT No.: PCT/IB03/05573

§ 371 Date: Jun. 7, 2005

(30) Foreign Application Priority Data
Dec. 11, 2002 (FR) 02 15638

(51) Int. Cl. H04B 17/00

(52) U.S. Cl. 455/67.11

(57) ABSTRACT

The invention relates to an integrated circuit (IC) comprising of a signal transmission channel (TX) including radio frequencies and a built-in tester (TEST) intended to test radio characteristics of said integrated circuit, said tester (TEST) comprising of—first means (COUPL) for recovering a part of the signal generated by the transmission channel (TX) at a first frequency (F0),—second means (M) for converting said recovered signal from the first frequency (F0) into a second frequency (F1),—an amplifier (A) for amplifying said signal at this second frequency (F1), and—a rectifier (R) for rectifying said signal.

### FIELD OF THE INVENTION

The invention relates to an integrated circuit comprising a radio frequency signal transmission channel. It also relates to a test method for such an integrated circuit and a tester for such an integrated circuit.

The invention finds application particularly in the transmitting section of mobile telephones.

### BACKGROUND OF THE INVENTION

A transmitter of a mobile telephone comprises an integrated circuit with a radio transmission channel having various characteristics such as power or spectral purity.

In order to test the functions of the integrated circuit during production, it is a well known practice to use a tester for integrated circuits that facilitates testing of various types of integrated circuits, said tester being connected to said circuit to be tested by an RF interface. The RF interface is generally made up of an electronic schematic on a printed circuit. Such a tester with its interface is known as ATE, or “Automatic Test Equipment”, and is manufactured by manufacturers such as Agilent, for example, the tester referred to as 3070 Series 3.

A first problem related to such testers is that the pre-qualification tests of the integrated circuit are performed in an environment determined by the manufacturer of these circuits, particularly on silicon wafers. The advantage of this pre-qualification test on the wafer is that the rejection of defective parts will cost less now than if the circuit were in its final application environment (the circuit is then packaged in its casing). It is, however, crucial to test the circuits once again in their final environment as it is necessary to identify the circuits that function error-free in the manufacturer's environment, but no longer do so in the client's environment. The case of an incomplete test process could result in client returns, which must be avoided.

A second problem is that the RF interface of such testers is very complex both in use and in future maintenance. In fact, this interface must be capable of capturing the signal transmitted by an external test circuit and transmitting it to the tester, which will verify whether the radio signal has indeed been sent: (Power of the RF signal correct, understanding of the signal transmitted owing to a tolerable number of errors, etc.). On the other hand, this RF interface not only depends on components that are used to build it and on the position of the circuit, but also on other parameters such as RF couplings or interferences that give rise to complications when the tests are carried out.

A third problem stems from the fact that the entire tester having RF test capacities is costly owing to its complexity, especially due to the fact that the tester must be multi-purpose, i.e. must be able to test all types of circuits integrating radio frequencies (for example, “GSM”, “BlueTooth”, “MTS”, “Zigbee” etc.), which considerably limits the stock and availability of testers among the manufacturers of circuits, for example, for reasons of costs.

### SUMMARY OF THE INVENTION

Thus a technical problem to be solved by an object of the present invention is to propose an integrated circuit comprising a signal transmission channel including radio frequencies as well as a test method of such an integrated circuit, both of which make it possible to solve the problems mentioned above.

To this effect, a first object of the invention is to propose an integrated circuit comprising a signal transmission channel including radio frequencies and an integrated tester intended to test radio characteristics of said integrated circuit, said tester comprising:

first means for recovering a part of the signal generated by the transmission channel at a first frequency,

second means for converting said recovered signal from the first frequency into a second frequency,

an amplifier for amplifying said signal at this second frequency, and

a rectifier for rectifying said signal.

A second object of the invention is to propose an integrated circuit test method comprising a signal transmission channel including radio frequencies, said method being intended to test radio characteristics of said integrated circuit and being independent of said transmission channel, said method comprising the following steps:

recovering a part of the signal generated by the transmission channel at a first frequency,

converting the first frequency of the recovered signal into a second frequency,

amplifying said signal at this second frequency, and

rectifying said signal.

A third object of the invention is to propose an integrated circuit tester for testing radio characteristics of a transmission channel of an integrated circuit, said tester being intended to be integrated with said integrated circuit and comprising:

first means for recovering a part of the signal generated by the transmission channel at a first frequency,

second means for converting said signal recovered from the first frequency into a second frequency,

an amplifier for amplifying said signal to this second frequency, and

a rectifier for rectifying said signal.

Thus, as will be demonstrated further below, the tester being incorporated in said circuit, no longer requires any complex RF interface to be implemented, the test environment is the same both at the circuit manufacturer's premises and at the final client's premises, as the radio signals are tested internally in the circuit itself and finally the tester can be multi-tasking, in other words, it can test several circuits at the same time. In addition, the tester is independent of the circuit to be tested; hence the tests are highly reliable.

Preferably, according to a non-limitative embodiment, the integrated circuit tester further comprises detection means for detecting the validity of the signal generated by the transmission channel.

Preferably, according to a non-limitative embodiment, the integrated circuit tester further comprises a filter for filtering harmonics of said signal.

Preferably, according to a non-limitative embodiment, the first frequency is a radio frequency and the second frequency is a low frequency.

Preferably, according to a non-limitative embodiment, the test method further comprises a step of detecting the validity of the signal generated by the transmission channel.

Preferably, according to a non-limitative embodiment, the test method further comprises a step of filtering harmonics of said signal.

Preferably, according to a non-limitative embodiment, the tester further comprises detection means for detecting the validity of the signal generated by the transmission channel.

Preferably, according to a non-limitative embodiment, the tester further comprises a filter for filtering harmonics of said signal.

### BRIEF DESCRIPTION OF THE DRAWINGS

The invention will be further described with reference to examples of embodiments shown in the drawings to which, however, the invention is not restricted.

FIG. 1 is an illustration of a transmission channel and the tester of the integrated circuit according to the invention,

FIG. 2 represents a part of a signal taken off at the output of the transmission channel of the integrated circuit of FIG. 1,

FIG. 3 represents the part of the signal taken off at the output of the transmission channel of the integrated circuit of FIG. 1, in the time domain,

FIG. 4 is an illustration of the signal of FIG. 3 before conversion into low frequency in the frequency domain,

FIG. 5 is an illustration of the signal of FIG. 3 after conversion into low frequency in the time domain,

FIG. 6 represents the signal of FIG. 5 in the time domain,

FIG. 7 represents the signal of FIG. 6 after rectification of negative alternations, and

FIG. 8 represents the signal of FIG. 7 after filtering as well as the two levels used to decide while testing whether or not the transmitted power ranges within the two minimum and maximum tolerable values.

### DESCRIPTION OF THE INVENTION

In the description that follows, the functions or structures well known to those skilled in the art will not be described, as they would unnecessarily encumber the description.

Moreover, in the presentation that follows, the term RF used signifies Radio Frequency.

This description of the invention relates to an example of an integrated circuit used in the field of mobile telephony, and in particular integrated in a transmitter of a mobile telephone.

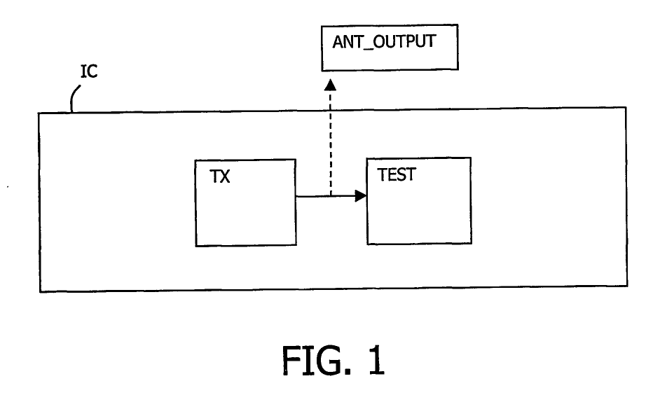

Such an integrated circuit IC is depicted in FIG. 1. It comprises a transmission channel TX that sends a signal to a receiver such as a base station. For communicating correctly with the base station, the transmission channel TX must have certain characteristics defined in accordance with the communication standard used by the mobile comprising said integrated circuit IC. Thus for the “BlueTooth” standard well known to a man of skill in the art and described in the document “BlueTooth specifications, vol. 1, version 1.1, February 2001”, for instance the transmission channel TX must provide an output power of 0 dBm (1 mW) for its power amplifier PA for the “BlueTooth” standard, in class 3.

To ensure an optimal communication between the mobile and the base station, it is necessary to test all the characteristics of the transmission channel TX for verifying whether said characteristics conform to the communication standard used.

To this end, the transmitter comprises an integrated circuit containing a transmission channel tester TEST and the transmission channel TX. It may be noted that the tester TEST is embedded in the integrated circuit IC on the aerial input/output ANT_OUTPUT.

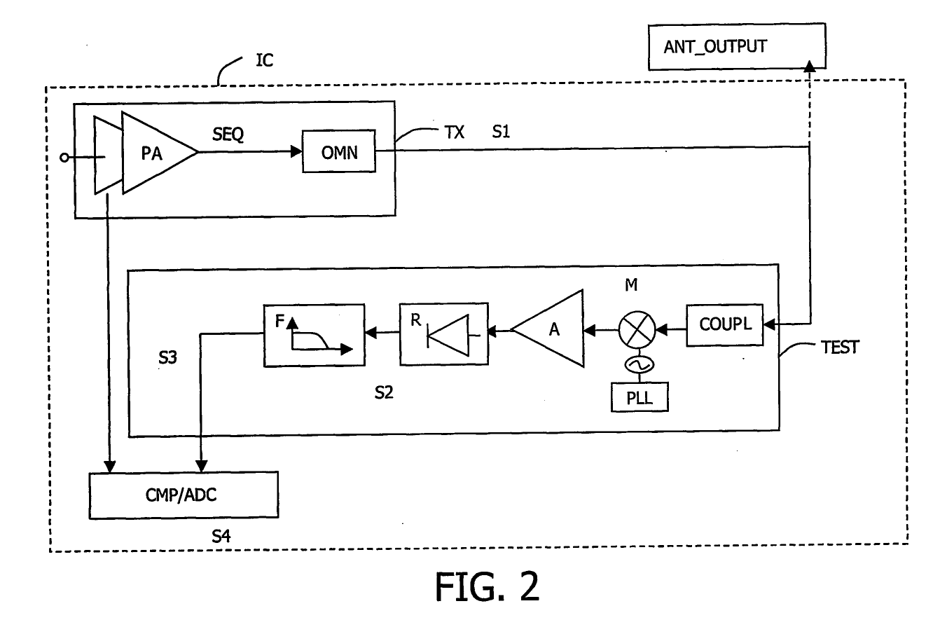

The integrated circuit IC is illustrated in FIG. 2. As it may be seen, the transmission channel TX comprises:

A power amplifier PA and

An external impedance matching network, commonly called OMN “Output Matching Network”

The tester TEST comprises:

First means COUPL for recovering a weak part of the RF signal generated by the transmission channel TX at a first frequency F0 (high frequency or radio frequency), Second means for converting said RF signal recovered from the first frequency F0 into a second frequency F1 (low frequency), said second means comprising a mixer M using an oscillator for carrying out the change of frequency, said oscillator being locked by a phase lock loop PLL for tuning the mixer M to a desired frequency,

A gain amplifier A for amplifying said signal to the second frequency F2,

A rectifier R for rectifying said signal, and

A filter F for eliminating the harmonics of said signal.

It will be noted that the first means COUPL is preferentially a coupler. It may alternatively be a system of switches.

In order to test the characteristics of the transmission channel TX, the tester TEST, staring from an analog RF signal S1 generated by the transmission channel TX, generates a low frequency, the characteristics of which are compared with reference characteristics V. The comparison makes it possible to verify whether the power level is well within the range expected.

A detailed description for the testing of the transmission channel TX is as follows. As an example of a non-restrictive characteristic to be tested, let us take the characteristic of power of the transmission channel, i.e. we will test whether the power amplifier PA transmits an analog signal S1 with the correct power.

The transmission channel TX generates the analog signal S1. During normal functioning, i.e. when the IC chip functions in an application, for example: Bluetooth type, the analog signal S1 generated by the transmission channel TX is sent to a receiver such as a base station.

It will be noted that the transmission channel TX of the chip comprises an Output Matching Network OMN at the output of the power amplifier PA, as it is necessary to match the output impedances of the IC chip with the antenna impedances ANT. Only a negligible part of the signal is taken off by the coupler, to be transmitted to the test circuits TEST.

During operation in the test mode, in a first step, the coupler COUPL takes off preferably a very weak part S1 of the analog signal generated by the transmission channel TX. For instance, in the case where said analog signal has a power of 0 dBm, the part taken off has a power of −30 dBm (a thousand times less). In fact, in normal operation of the IC chip, the analog signal is also constantly taken off by the tester TEST. It is therefore necessary not to disrupt the transmitted analog signal and consequently the normal functioning of the chip, by taking off only a small part. Of course, to avoid recovering all or part of the signal by the tester TEST during the normal functioning of the chip, it is also possible to add a set of switches to activate or deactivate the tester TEST in the test mode or in the functional mode, respectively. However, this solution presents disadvantages as the coupler COUPL introduces parasitic elements.

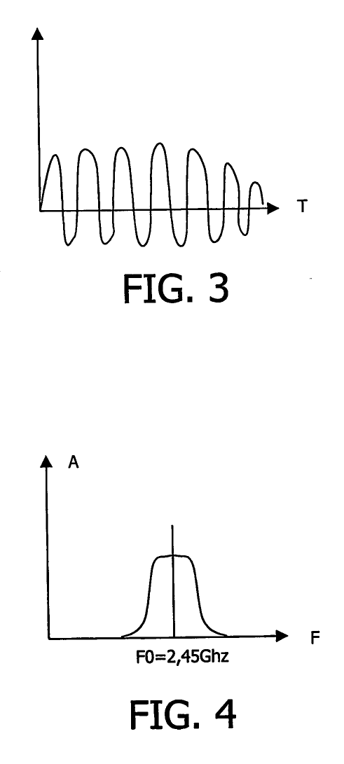

The signal S1 at the input of the coupler COUPL is represented in FIG. 3 in the time domain and an example of its spectrum is illustrated in FIG. 4 in the case where the communication standard used is “BlueTooth”. As may be noted in FIG. 4, the spectrum is centered on a frequency F0 of 2.45 GHz, the radio frequency of the “BlueTooth” standard.

In a second step, the mixer M decreases said signal S1 in frequency from 2.45 GHz to a few MHz (second frequency F1, also called intermediate frequency), as may be seen in FIG. 6. Thus, the mixer M carries out a conversion from a high frequency to a low frequency.

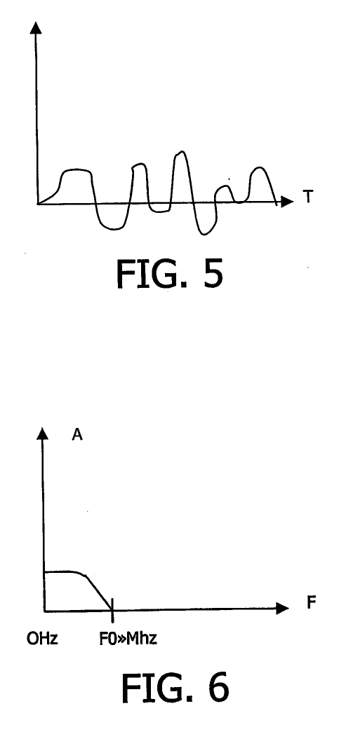

The signal S1 thus transformed is represented in FIG. 5. The fact of having a low-frequency signal S1 renders subsequent testing easier.

On the other hand, the amplitude of this signal has been decreased in comparison with the analog signal from which it was derived. In fact, the situation is that the tester recovers only a part of the analog signal generated by the transmission channel TX. In this case, the coupler possesses an attenuation, for instance of 30 dB, i.e. it has recovered only 1/1000 of the source signal, this in order to limit losses owing to the coupler COUPL.

In a third step, the gain amplifier A amplifies the low-frequency signal S1. In fact, given that the source signal has been considerably attenuated, it is necessary to amplify it in order to manage it correctly subsequently. Thus, the gain amplifier A possesses, for instance, a gain of 60 dB, which corresponds to multiplying the power of the recovered signal S1 by 10⁶.

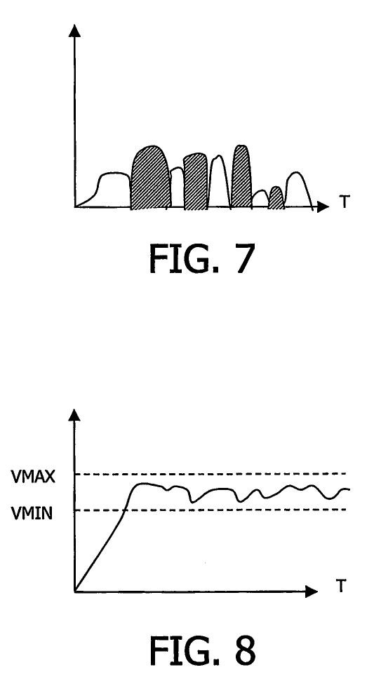

In a fourth step, from the amplified signal S1 the rectifier R makes it possible to obtain a signal S2 whose DC component is proportional to the power of the signal at the output of PA. As may be seen in FIG. 7, all the negative alternations of the amplified signal S2 have been rectified.

In a fifth step, the filter F eliminates the harmonics of the peaked signal S2 and permits to obtain an average value of said signal S1, as may be seen in FIG. 8. The filter R is a low-pass filter with a cut-off frequency of 1 MHz for instance, which allows only the DC component of the signal S1 to pass, the mixer being configured to 1 MHz. This average value ranges between two values, a minimum voltage Vmin and a maximum voltage Vmax. Thus, we have a signal S2 with a stabilized power (voltage) at the output of the tester TEST.

In order to test the power characteristic of the transmission channel TX, the detection means CMP verifies the validity of a signal, for example, for an analog transmitted signal S1, whether the power of this signal is correct, based on the signal obtained at the output of the tester TEST. To this end, in a first preferred embodiment, the detection means CMP is a comparator. The comparator then compares the output signal of the tester with two values Vmin and Vmax, minimum and maximum voltage values, reference values characteristic of the desired power of the signal S1.

In a second embodiment, the detection means CMP is an analog-to-digital converter ADC. This converter converts the signal S3 obtained after filtering into a digital signal S4. This signal S4 is compared with two digital codes which have a minimum and a maximum, characterizing the power of the analog RF signal transmitted by the transmission channel. If the digital signal S4 obtained ranges between these two codes, the power of the transmission channel TX is acceptable. In the opposite case, the tested circuit is declared defective.

The transmission channel TX must have an output power of 0 dbm, for instance in “Bluetooth”.

In practice, this power guarantees the scope of communication between the mobile and a receiver, such as a base station.

It will of course be noted that other characteristics of the transmission channel TX may be tested, such as the spectral purity of the transmitted signal.

Thus, the “self-test” of the IC chip is carried out by a tester integrated with said chip, however, which remains independent of it. This adds an estimated silicon surface cost of +10 to +15%. However, this additional cost is largely compensated by: a shorter test time thanks to signals that stabilize faster; a tester cost considerably reduced thanks to the use of only an analog/digital or digital tester instead of an RF tester, a multi-site tester that further decreases the test time thanks to simultaneous data acquisition for several integrated circuits.

It will also be noted that the power consumption is greater than in an integrated circuit without tester. However, this consumption has no impact on the normal functioning of the chip, as the tests are not carried during its normal functioning. Thus integrating the tester with the chip has no influence on the latter in the normal mode.

Thus, the invention presents a number of advantages as listed below.

First, the integrated circuit manufacturer is no longer dependent on the suppliers of testers, on their delivery lead times, on their technology, as he can himself carry out his tests with the tester according to the invention.

Second, the tester according to the invention, though integrated with the integrated circuit to be tested, is independent of the transmission channel of the latter, as it is not said channel that supplies the references sequences SEQ. Furthermore, said tester is a block truly independent of the transmission channel and of any other channel. Consequently, the tests are reliable and not truncated, unlike solutions in which, for example a reception channel is used for testing the transmission channel, which is bad from a metrological point of view.

Moreover, as said tester is independent, the design of the chip does not have to be reviewed. It is possible to integrate this tester without any difficulty with any chip without this activity being expensive in terms of design time. This idea of “reuse” facilitates the development of libraries of test blocks.

On the other hand, the fact that the tester is integrated with the integrated circuit to be tested makes it possible to do away with the radio-frequency interface. This prevents disturbances in the RF signal. Moreover, the tester is no longer separated from the transmission channel by such an interface, and is therefore placed only a few micrometers from this channel, as against a few millimeters in the prior art, which reduces disturbances to a large extent. Lastly, the fact of no longer having any RF interface helps to minimize development costs and obtain a simpler tester.

Third, the fact of having on the output analog or digital information available makes the analysis of the chip easier. Thus, one can know more easily whether the chip is workable or not.

Fourth, as RF signals are generated internally in the integrated circuit, the same environment is used for the tests at the manufacturer's premises and for the final tests at the client's premises. This avoids errors arising from changes in environment, the former tests being carried out on a wafer at the manufacturer's premises, and the latter tests on the chip in its casing . . . even at the client's premises.

Fifth, it may be noted that it is possible to test several chips in parallel simultaneously, which ensures high performance in terms of rapidity of the tests. In fact, it is sufficient to acquire the digital values in parallel, and to read them. The conventional scenario of the state of the art in RF testing is mono-site, i.e. the manufacturer can test only one chip at a time because it is not known how to acquire RF signals in parallel, and given the cost of the tests, it is necessary to have different RF signal transmitting sources adapted to each integrated circuit to be tested.

Sixth, it may be noted that the filter F of the tester TEST stabilizes after a few microseconds. This has the advantage of carrying out test measurements in a few microseconds. In fact, after the mixer M, there is a low frequency of a few Mega hertz for instance, as we have seen earlier in FIG. 6, which corresponds to 10 periods of 100 nano sec and therefore measurement times of a few microseconds.

Lastly, it may be noted that an expert skilled in testing integrated circuits would not be inclined to integrate the tester with said integrated circuit, as in general, he receives said integrated circuit, places it on a printed circuit and prepares the cables for connecting said integrated circuit to said printed circuit to carry out the tests.

On the other hand, the expert skilled in designing integrated circuit would not be inclined to integrate the tester with said integrated circuit, as in general his major concern is to design an increasingly smaller integrated circuit that consumes less and less power, which goes against the idea of inserting the tester into the integrated circuit.

Of course, the scope of the present invention is by no means limited to the embodiments described, and variations or modifications may be made without departing from the spirit and scope of the invention.

Of course, the invention is not in any manner limited to the field of mobile telephony, it may be extended to other fields, particularly those that use an integrated circuit comprising a transmission channel a circuit on which tests must be carried out, such as fields related to telecommunications, for example, standards like “BlueTooth”, “GSM”, “UMTS” “Cordless and cellular phones”, “WLAN”, etc.

No sign of reference in the present text must be interpreted as limiting said text.

The verb “to comprise” and its conjugations must not be understood in a restrictive manner, i.e. they must not be interpreted as excluding the presence of other steps or elements than those defined in the description, or, as excluding a plurality of steps or elements already listed after said verb and preceded by the article “a” or “an”.

1. An integrated circuit (IC) comprising a signal transmission channel (TX) including radio frequencies and an integrated tester (TEST) intended to test radio characteristics of said integrated circuit, said tester (TEST) comprising:
first means (COUPL) for recovering a part of the signal generated by the transmission channel (TX) at a first frequency (F0),
second means (M) for converting said recovered signal from the first frequency (F0) into a second frequency (F1),
an amplifier (A) for amplifying said signal at this second frequency (F1), and
a rectifier (R) for rectifying said signal.

2. An integrated circuit (IC) as claimed in claim 1, characterized in that the tester further comprises detection means (CMP/ADC) for detecting the validity of the signal generated by the transmission channel (TX).

3. An integrated circuit (IC) as claimed in claim 1, characterized in that the tester further comprises a filter (F) for filtering harmonics of the signal.

4. An integrated circuit (IC) as claimed in claim 1, characterized in that the first frequency (F0) is a radio frequency and the second frequency (F1) is a low frequency.

5. A method of testing an integrated circuit (IC) comprising a signal transmission channel (TX) including radio frequencies, said method being intended to test radio characteristics of said integrated circuit and being independent of said transmission channel, said method comprising the following steps:
recovering a part of the signal generated by the transmission channel (TX) at a first frequency (F0),
converting the first frequency (F0) of the recovered signal into a second frequency (F1),
amplifying said signal at this second frequency (F1), and
rectifying said signal.

6. A method of testing an integrated circuit (IC) as claimed in claim 5, characterized in that it further comprises a step of detecting the validity of the signal generated by the transmission channel (TX).

7. A method of testing an integrated circuit (IC) as claimed in claim 5, characterized in that it comprises a step of filtering harmonics of said signal.

8. A tester (TEST) for testing radio characteristics of a transmission channel (TX) of an integrated circuit (IC), said tester (TEST) being intended to be integrated with said integrated circuit (IC) and comprising:
first means (COUPL) for recovering a part of the signal generated by the transmission channel (TX) at a first frequency (F0)
second means (M) for converting said signal recovered from the first frequency (F0) into a second frequency (F1)
an amplifier (A) for amplifying said signal to this second frequency (F1), and
a rectifier (R) for rectifying said signal.

9. A tester as claimed by claim 8, characterized in that it further comprises detection means (CMP/ADC) for detecting the validity of the signal generated by the transmission channel (TX).

10. A tester as claimed by claim 8, characterized in that it further comprises a filter (F) for filtering harmonics of said signal.

11. A transmitter comprising an integrated circuit (IC) comprising a tester as claimed in claim 8.
